(19) United States
(12) Patent Application Publication
(10) Pub. No.: US 2026/0124532 A1
(43) Pub. Date: May 7, 2026

(54) TACTILE/HAPTICS GENERATION

(71) Applicant: Sony Interactive Entertainment Inc., Tokyo (JP)

(72) Inventors: Sergey Bashkirov, San Mateo, CA (US); Lakshmish Kaushik, San Mateo, CA (US); Xiaoyong Ye, San Mateo, CA (US)

(21) Appl. No.: 18/938,141

(22) Filed: Nov. 5, 2024

(51) Int. Cl. A63F 13/285

(52) U.S. Cl. CPC A63F 13/285

(57) ABSTRACT

Non-AV output of a game and specifically tactile/haptics output on a controller is automatically generated by AI based on player motion, game content, and a virtual/real environment. This helps developers and gives players real time feedback on how well they are doing.

### FIELD

The present application relates generally to Tactile/haptics generation for computer games.

### BACKGROUND

As video games have become sophisticated and complex, in particular introducing the ability to provide more than simple audio and video of a game, the need has grown for effective generation of non-AV game output.

### SUMMARY

An apparatus includes at least one processor system configured to generate text describing one or more of computer game data and/or real world environment data and/or virtual world environment data and/or player motion data. The processor system is configured to input the text to at least one machine learning (ML) model, and, using an output of the ML model, generate a tactile signal using a haptics generator. The haptics generator can be on a computer game controller.

In another aspect, an apparatus includes computer memory that is not a transitory signal and that in turn includes instructions executable to input text related to computer game play to at least one machine learning (ML) model, and generate at least one tactile signal based at least in part on output from the ML model.

In another aspect, a method includes inputting text to at least one machine learning (ML) model, and generating a tactile signal according to an output of the ML model.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example specific system;

FIG. 3 is a block diagram of present techniques;

FIG. 4 illustrates example overall logic in example flow chart format;

FIG. 5 illustrates example logic in example flow chart format for training a model to generate text from player motion signals;

FIG. 6 illustrates example logic in example flow chart format for training a model to generate text from game content data;

FIG. 7 illustrates example logic in example flow chart format for training a model to generate text from a virtual and/or real environment; and

FIG. 8 illustrates example logic in example flow chart format for training a model to generate haptic signals from a text prompt.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

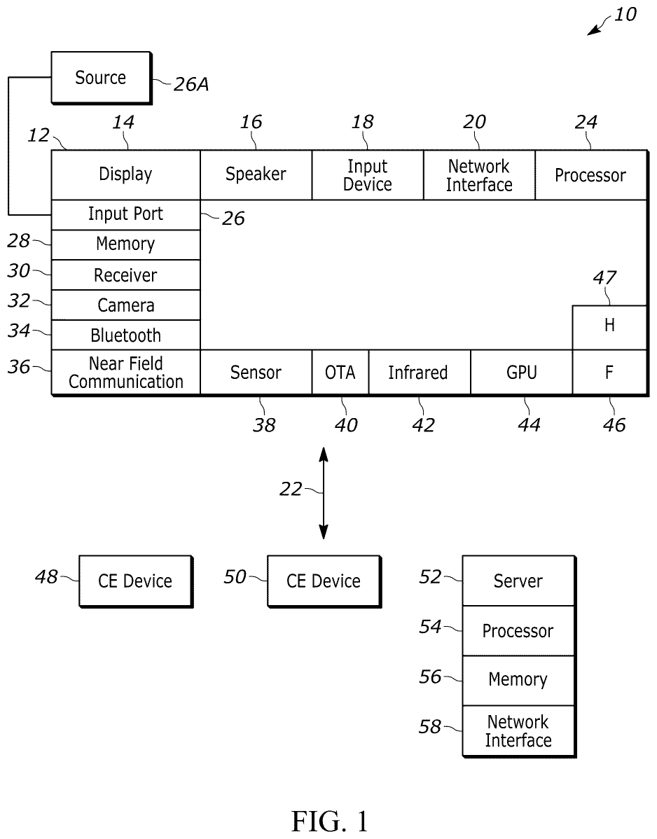

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) and other large language models (LLM) and more generally generative models (GM) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

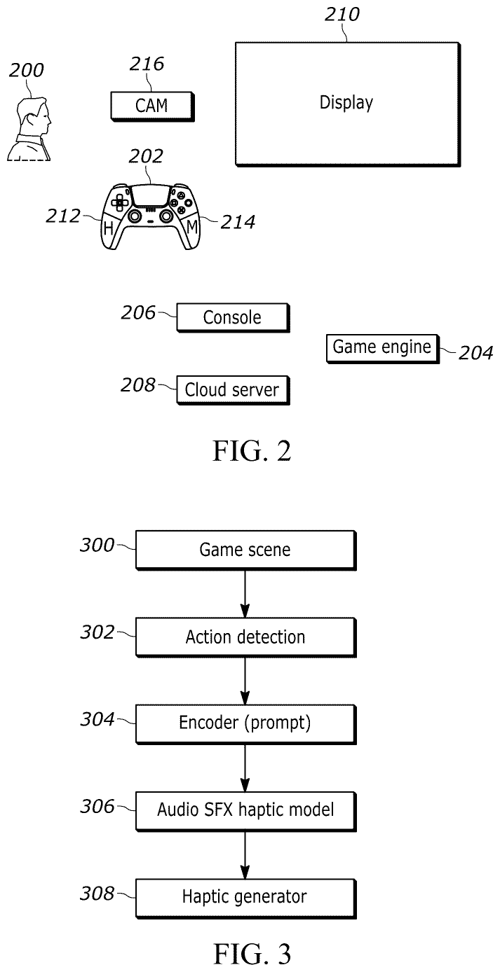

Refer now to FIG. 2. A player 200 can manipulate a computer game controller 202 to control a computer game from a game engine 204 hosted by a computer game console 206 and/or cloud server 208 and presented on a display 210. In the example shown, the controller 202 may include one or more haptic generators 212 and one or more motion sensors 214 such as inertial measurement units (IMU), gyroscopes, magnetometers, and the like. A camera 216 which may be part of the controller 202 or display 210 or console 206 can image the player 200 to detect player motion by means of machine vision implemented on the player images.

The system shown in FIG. 2 and represented further in FIG. 3 can be used to automatically generate non-AV output of a game and specifically tactile/haptics output on a controller 202 or other object using artificial intelligence (AI) based on game content 300, player motion 302, and a virtual/real environment. The player motion 302 may be derived from signals from the motion sensor 214 on the controller 202, machine vision implemented on images from the camera 216, and other sources of player motion signals. The game content may be from the game engine 204 in the form of AV content of the game and/or metadata. Real environment data may be received from temperature sensors, wind sensors, humidity sensors, and the like near the player 200, while virtual environment data may be received from the game engine 204. The virtual environment data may include information on emulated weather within the game, information on lighting within the game, information on geographic background in the game, etc. in the form of images and/or metadata Present principles assist developers by automatically generating game haptics and give players real time feedback on how well they are doing (lesser haptics for better players). The AI is trained on haptic (vibrations)/text pairs.

An encoder 304 generates text prompts that are sent to a decoder 306, which may be implemented by a machine learning (ML) model trained to generate commands for specific haptic signals from text prompts. The output of the decoder 306 is sent to one or more haptics generators 308 such as the haptics generator 212 in FIG. 2. The output of the decoder 306 may be a demand for a haptics signal having a specific waveform generated by the decoder.

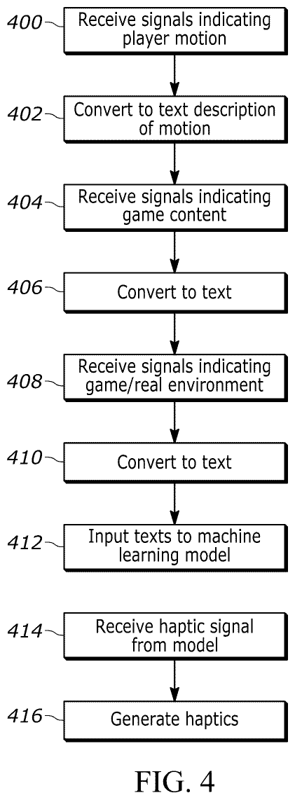

FIG. 4 illustrates overall logic. Commencing at state 400, signals indicating player motion are received and converted to text at state 402. At state 404 signals indicating game content are received and converted to text at state 406.

Moving to state 408, signals indicating a real world and/or virtual environment are received and converted to text at state 410. The text from one or more of states 402, 406, 410 is input to a ML model such as the decoder 306 shown in FIG. 3, which in response outputs a demanded haptics signal at state 414. The haptics signal is converted into a tactile signal at state 416 by the haptics generator(s) 308.

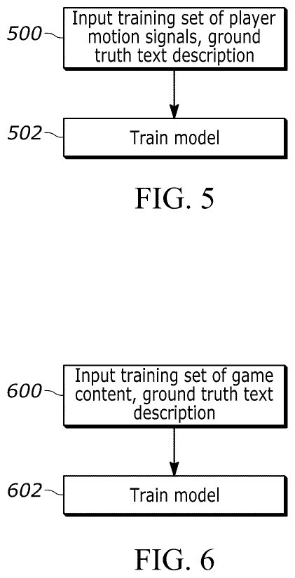

FIGS. 5-7 illustrate training logic for training one or more ML models to generate the texts at state 402, 406, 410 in FIG. 4. Individual models may be used for each state or a single model may be trained on all of the data shown in FIGS. 5-7.

Commencing at state 500, a training set of data is input to a ML model to train the model at state 502 to generate text from player motion signals. The input training can include sample player motion data with ground truth text descriptions of the motion signals.

On the other hand, commencing at state 600 in FIG. 6, a training set of data is input to a ML model to train the model at state 602 to generate text from game content data. The input training can include sample game content data with ground truth text descriptions of the game content data.

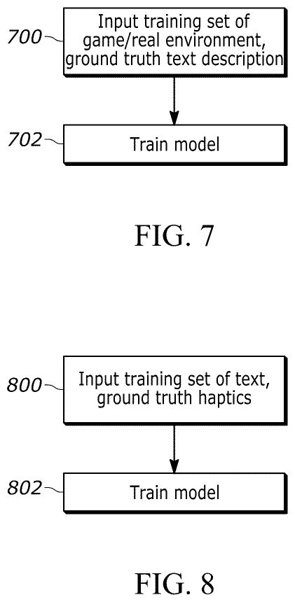

State 700 in FIG. 7 indicates that a training set of data is input to a ML model to train the model at state 602 to generate text from real and/or virtual environment information. The input training can include sample real and/or virtual environment information with ground truth text descriptions of the real and/or virtual environment information.

FIG. 8 illustrates inputting at state 800 a training set of text along with ground truth samples of accompanying haptics signals to a ML model to train the model at state 802 to generate haptics signals from text prompts. The text can include samples of outputs of the one or more models trained according to FIGS. 5-7 and the model trained according to FIG. 8 can serve as the decoder 306 in FIG. 3. The ML model trained according to FIG. 8 thus automatically generates haptics signals, which can be novel signals derived from training, based on player motion and/or real/virtual environment and/or game data.

In addition to the above, present principles may be extended to reducing the risk of a player immersed in a virtual world from bumping into real world (RW) objects, tripping over RW obstacles, or experiencing disorientation. Automatic haptic feedback can be used to enhance safety by providing tactile cues that alert players to RW hazards or guide them within the virtual space. So given real world scene data, player location, a tactile feedback generation system to guide or alert players can be trained.

More specifically, haptics can be combined with other sensory output. One or more ML models may be trained with multimodal data including audio and visual data, with haptic feedback being aligned with audio cues for example to create a more cohesive sensory experience. Vibrations, for example, can be synchronized with the sound effects in a game, or visual events in the game can be aligned to corresponding haptic responses.

While the particular embodiments are herein shown and described in detail, it is to be understood that the subject matter which is encompassed by the present invention is limited only by the claims.

What is claimed is:

1. An apparatus comprising:
at least one processor system configured to:
generate text describing computer game data and/or real world environment data and/or virtual world environment data and/or player motion data;
input the text to at least one machine learning (ML) model; and
using an output of the ML model, generate a tactile signal using a haptics generator.

2. The apparatus of claim 1, wherein the text describes computer game data.

3. The apparatus of claim 1, wherein the text describes real world environment data.

4. The apparatus of claim 1, wherein the text describes virtual world environment data.

5. The apparatus of claim 1, wherein the text describes player motion data.

6. The apparatus of claim 1, wherein the text describes at least two of computer game data, real world environment data, virtual world environment data, player motion data.

7. The apparatus of claim 1, wherein the text describes all of computer game data, real world environment data, virtual world environment data, player motion data.

8. The apparatus of claim 1, wherein the haptics generator is on a computer game controller.

9. An apparatus comprising:
computer memory that is not a transitory signal and that comprises instructions executable to:
input text related to computer game play to at least one machine learning (ML) model; and
generate at least one tactile signal based at least in part on output from the ML model.

10. The apparatus of claim 9, wherein the text describes computer game data.

11. The apparatus of claim 9, wherein the text describes real world environment data.

12. The apparatus of claim 9, wherein the text describes virtual world environment data.

13. The apparatus of claim 9, wherein the text describes player motion data.

14. The apparatus of claim 9, wherein the text describes at least two of computer game data, real world environment data, virtual world environment data, player motion data.

15. The apparatus of claim 9, wherein the text describes all of computer game data, real world environment data, virtual world environment data, player motion data.

16. The apparatus of claim 1, wherein the tactile signal is generated on a computer game controller.

17. A method, comprising:
inputting text to at least one machine learning (ML) model; and
generating a tactile signal according to an output of the ML model.

18. The method of claim 17, wherein the text describes computer game data.

19. The method of claim 17, wherein the text describes real world and/or virtual world environment data.

20. The method of claim 17, wherein the text describes player motion data.
